(19) United States
(12) Patent Application Publication
(10) Pub. No.: US 2024/0294430 A1
(43) Pub. Date: Sep. 5, 2024

(54) ENVIRONMENT-FRIENDLY SOUND-INSULATION RUBBER MORTAR AND PREPARATION METHOD THEREOF

(71) Applicant: GUANGDONG UNIVERSITY OF TECHNOLOGY, GUANGZHOU (CN)

(72) Inventors: ZHE XIONG, GUANGZHOU (CN); JUAN WANG, GUANGZHOU (CN); CAIHONG LI, GUANGZHOU (CN); ZHENXING TANG, GUANGZHOU (CN); ZHEN FANG, GUANGZHOU (CN); FENG LIU, GUANGZHOU (CN)

(21) Appl. No.: 18/665,553

(22) Filed: May 15, 2024

Related U.S. Application Data
(63) Continuation of application No. PCT/CN2023/082634, filed on Mar. 21, 2023.

(30) Foreign Application Priority Data
Jun. 12, 2022 (CN) 202210660524.8

(51) Int. Cl. C04B 28/04; C04B 14/06; C04B 16/02; C04B 18/22; C04B 111/52

(52) U.S. Cl. CPC C04B 28/04; C04B 14/068; C04B 16/02; C04B 18/22; C04B 2111/52

(57) ABSTRACT

The present disclosure provides an environment-friendly sound-insulation rubber mortar and a preparation method thereof, belongs to the technical field of building materials. The environment-friendly sound-insulation rubber mortar of each cubic meter is prepared with the following materials: cement of 349.6-480.2 kg, water of 175.1-240.5 kg, river sand of 634.3-1033.0 kg, rubber of 121.7-328.9 kg, special glue for sound insulation of 0.1-121.8 kg, re-dispersible latex powder of 1.4-1.9 kg, and cellulose ether of 1.4-1.9 kg. The special glue for sound insulation is a water-based polyvinyl acetate adhesive.

### CROSS-REFERENCE OF RELATED APPLICATIONS

This application is a continuation of International Application PCT/CN2023/082634 filed on Mar. 21, 2023, which claims priority to Chinese Patent Application No. 202210660524.8 filed on Jun. 12, 2022. The above-mentioned applications are hereby incorporated by reference in their entireties.

### TECHNICAL FIELD

The present disclosure relates to the field of building materials, and in particular to an environment-friendly sound-insulation rubber mortar and a preparation method thereof.

### BACKGROUND

As an important building material, cement mortar is widely used in constructional engineering. However, with the progress of science and the continuous improvement of people's living standards, the noise, being a negative factor that affects the life, has been paid more and more attention. With the rapid development of economy, it promotes the development of the automobile industry and the transportation industry, which in turn promotes the development of the tire and rubber industry. Correspondingly, more and more waste rubbers are produced every year. Waste rubber is a kind of polymeric material, which is difficult to degrade under general natural conditions. If the waste rubber is directly landfilled, the groundwater resources would be affected. If the waste rubber is directly burned, a large amount of toxic gas would be released, which would further worsen the environmental problems such as “black pollution”. At present, recycling of the waste rubber is an urgent problem to be solved in the sustainable development strategy, and it is also a worldwide research hotspot.

At present, the research shows that, compared with a traditional cement-based material, a rubber-and-cement based material made by adding the waste rubber into the cement-based material has better ductility, sound insulation, heat preservation, impact resistance and durability. For example, in the related art CN202010464326.5, it discloses a sound insulation mortar with excellent flexural and compressive properties and a preparation method thereof, which realizes its purpose mainly by distributing rubber powder on the surface of the fiber. In addition, CN201810827558.5 discloses a thermal-insulation and sound-insulation mortar, in which the sound insulation performance of the rubber is improved through modification with the waste rubber powder. Further, CN201310696284.8 discloses that the sound insulation performance of the mortar is improved by using the waste rubber, and CN202110372498.4 also discloses that the waste rubber is utilized for the problem of rubber sound insulation.

However, in actual production, the rubber-and-cement based material is rarely applied in civil engineering. There are two main reasons for this situation. On one hand, the rubber-and-cement based material lacks a comprehensive and systematic knowledge hierarchy, which makes civil engineering practitioners unable to fully know the advantages thereof. The rubber-and-cement based material currently is mainly used for civil engineering materials which have low requirements for compressive and flexural strengths. For example, the rubber-and-cement based material is made into the sound-insulation rubber mortar for building floors or wall coating. On the other hand, the compressive and flexural properties of the rubber-and-cement based material are reduced due to the addition of the waste rubber, which limits the development of the rubber-and-cement based material.

### SUMMARY

Embodiments of the present disclosure provide an environment-friendly sound-insulation rubber mortar. The mortar of each cubic meter is prepared with materials (in mass ratio) as follows: 200-300 parts of cement, 100-150 parts of water, 500-600 parts of river sand, 180-220 parts of rubber, 0.1-90 parts of special glue, 1-10 parts of re-dispersible latex powder, and 1-10 parts of cellulose ether, the waste rubber particles are mixed particles of granular rubber particles and columnar rubber particles, a mass ratio of the granular rubber particles to the columnar rubber particles is (2-3): 1, and an apparent density of the waste rubber particles is 920-985 kg/m³, and the river sand is medium sand, and the river sand has a fineness modulus of 2.41, a water absorption rate of 0.38%, and a water content of 0.34%.

The present disclosure further provides a method for preparing an environment-friendly sound-insulation rubber mortar, and the method includes steps as follow:
(1) preparing materials for the mortar in such a manner that the mortar of each cubic meter contains materials (in mass ratio) as follows: 200-300 parts of cement, 100-150 parts of water, 500-600 parts of river sand, 180-220 parts of rubber, 0.1-90 parts of special glue, 1-10 parts of re-dispersible latex powder, and 1-10 parts of cellulose ether;
(2) wetting a mixer and stirring blades, to prevent an inner wall and the blades of the mixer from being excessively dry, and avoid fluidity of the rubber mortar from being affected;
(3) pouring the rubber and the special glue into the mixer, and making the stirring blades stir at a speed of 62±5 r/min for 30-50 s;
(4) pouring one third of the water into the mixer, and making the stirring blades stir at the speed of 62±5 r/min for 30 s;
(5) pouring the cement, the cellulose ether, the re-dispersible latex powder and residual water into the mixer, and making the stirring blades stir at the speed of 62±5 r/min for 30 s;
(6) pouring the river sand into the mixer, and making the stirring blades stir at the speed of 62±5 r/min for 30 s; and
(7) suspending the mixer and scraping the mortar located on the wall and the stirring blades of the mixer into the mixer, and then making the stirring blades stir at a speed of 125±10 r/min for 60 s, to obtain a fresh mortar.

### BRIEF DESCRIPTION OF THE DRAWINGS

FIG. 1 is a flowchart of a method for preparing a sound-insulation rubber mortar.

FIG. 2 is a diagram illustrating fluidity results of sound-insulation rubber mortars.

FIG. 3 is a diagram illustrating flexural strength results of the sound-insulation rubber mortars.

FIG. 4 is diagram illustrating compressive strength results of the sound-insulation rubber mortars.

FIG. 5 is a diagram illustrating impact strength results of the sound-insulation rubber mortars.

FIG. 6 is a diagram illustrating drying shrinkage results of the sound-insulation rubber mortar test specimens on the 91st day.

FIG. 7 is a diagram illustrating combined weights of the sound-insulation rubber mortars in various embodiments.

FIG. 8 is a diagram illustrating results of a sound insulation test of the test specimen R50Z8F0.4.

### DETAILED DESCRIPTION OF PREFERRED EMBODIMENTS

In order to better understand the present disclosure, it is now illustrated in detail by means of the following embodiments. The following embodiments fall within the protection scope of the present disclosure, but do not limit the protection scope of the present disclosure.

The present disclosure mainly makes improvements for the sound insulation problem and mechanical properties of the sound-insulation rubber mortar in the related art, in order to meet the good sound insulation requirements without affecting the mechanical properties of the mortar.

Embodiments of the present disclosure provide an environment-friendly sound-insulation rubber mortar. The mortar of each cubic meter is prepared with materials (in mass ratio) as follows: 200-300 parts of cement, 100-150 parts of water, 500-600 parts of river sand, 180-220 parts of rubber, 0.1-90 parts of special glue, 1-10 parts of re-dispersible latex powder, and 1-10 parts of cellulose ether.

Further, the cement is ordinary Portland cement with a label of P.042.5R or P. S. A32.5, and a density of the cement is about 3200 kg/m³.

Further, the water is ordinary tap water, with a density of 995 kg/m³.

Further, the river sand is medium sand, where a fineness modulus of the river sand is 2.41, a water absorption rate of the river sand is 0.38%, and a water content of the river sand is 0.34%.

Further, the rubber is waste rubber particles. The waste rubber particles are granular rubber particles, with a particle size of 2-4 mm and an apparent density of 985 kg/m³. Alternatively, the waste rubber particles are columnar rubber particles, an average diameter of the columnar rubber particles is 1-2 mm, and a length-diameter ratio of the columnar rubber particles is 3-5. Alternatively, the waste rubber particles are mixed particles of the granular rubber particles and the columnar rubber particles, a mass ratio of the granular rubber particles to the columnar rubber particles is (2-3):1, a particle size of the granular rubber particles is 2-4 mm, a diameter of the columnar rubber particles is 1-2 mm, and a length-diameter ratio of the columnar rubber particles is 3-5.

Further, the rubber is one or more selected from natural rubber, synthetic rubber, styrene-butadiene rubber, polybutadiene rubber, chloroprene rubber, nitrile rubber, ethylene propylene rubber, polyurethane rubber, polysulfide rubber, acrylate rubber and epichlorohydrin rubber.

Further, the special glue for sound insulation includes one or more selected from rubber latex, polyvinyl acetate, urea-formaldehyde, lignin, sodium alkyl sulfonate and guar gum, where the polyvinyl acetate is an ivory water-based polyvinyl acetate adhesive.

Further, the re-dispersible latex powder is specifically one or more selected from an ethylene/vinyl acetate copolymer, a vinyl acetate/vinyl tertiary carbonate copolymer, and an acrylic acid copolymer, where the re-dispersible latex powder has a bulk density of 464 kg/m³, a density of 1049 kg/m³, a specific surface area of 346.7 m²/kg, a PH value of 8.2, and an ash content of 9%.

Further, the cellulose ether is hydroxypropyl methyl cellulose ether (HPMC), or is alternatively one or more selected from methyl cellulose ether, methyl hydroxyethyl cellulose ether and hydroxyethyl cellulose ether.

The present disclosure further provides a method for preparing an environment-friendly sound-insulation rubber mortar, and the method includes steps as follow:
(1) preparing materials for the mortar in such a manner that the mortar of each cubic meter contains materials (in mass ratio) as follows: 200-300 parts of cement, 100-150 parts of water, 500-600 parts of river sand, 180-220 parts of rubber, 0.1-90 parts of special glue, 1-10 parts of re-dispersible latex powder, and 1-10 parts of cellulose ether;
(2) wetting a mixer and stirring blades, to prevent an inner wall and the blades of the mixer from being excessively dry, and avoid fluidity of the rubber mortar from being affected;
(3) pouring the rubber and the special glue into the mixer, and making the stirring blades stir at a speed of 62±5 r/min for 30-50 s;
(4) pouring one third of the water into the mixer, and making the stirring blades stir at the speed of 62±5 r/min for 30 s;
(5) pouring the cement, the cellulose ether, the re-dispersible latex powder and residual water into the mixer, and making the stirring blades stir at the speed of 62±5 r/min for 30 s;
(6) pouring the river sand into the mixer, and making the stirring blades stir at the speed of 62±5 r/min for 30 s; and
(7) suspending the mixer and scraping the mortar located on the wall and the stirring blades of the mixer into the mixer, and then making the stirring blades stir at a speed of 125±10 r/min for 60 s, to obtain a fresh mortar.

Further, in step (1), a water cement ratio of the mortar is 0.2-0.8; and a volume ratio of the cement to fine aggregate (the river sand and the rubber) is 1:2-1:4, and preferably 1:3.

The rubber is added into the mortar by replacing the river sand of an equal volume, with a replacement rate of 20-60%, and preferably 30%, 35%, 40%, 45%, 50%, or 55%. Based on calculation by a mass percentage of the mortar, a content ratio of the special glue for sound insulation is 0.1-10%. Based on calculation by a mass percentage of the cement, a content ratio of each of the re-dispersible latex powder and the cellulose ether is 0.1-0.8%, preferably 0.2%, 0.3%, 0.4%, 0.5%, 0.6%, or 0.7%.

Further, the cement is ordinary Portland cement with a label of P.O42.5R, or the cement is slag Portland cement with a label of P.S.A32.5, and a density of the cement is 3200 kg/m³.

Further, the water is ordinary tap water, with a density of 995 kg/m³.

Further, the river sand is medium sand, and the river sand has a fineness modulus of 2.41, a water absorption rate of 0.38%, and a water content of 0.34%.

Further, the rubber is waste rubber particles. The waste rubber particles are granular rubber particles, with a particle size of 2-4 mm. Alternatively, the waste rubber particles are columnar rubber particles, where an average diameter of the columnar rubber particles is 1-2 mm, and a length-diameter ratio of the columnar rubber particles is 3-5. Alternatively, the waste rubber particles are mixed particles of the granular rubber particles and the columnar rubber particles, a mass ratio of the granular rubber particles to the columnar rubber particles is (2-3):1, and an apparent density of the waste rubber particles is 920-985 kg/m³.

Further, the rubber is one or more selected from natural rubber, synthetic rubber, styrene-butadiene rubber, polybutadiene rubber, chloroprene rubber, nitrile rubber, ethylene propylene rubber, polyurethane rubber, polysulfide rubber, acrylate rubber and epichlorohydrin rubber.

Further, the special glue for sound insulation includes one or more selected from rubber latex, polyvinyl acetate, urea-formaldehyde, lignin, sodium alkyl sulfonate and guar gum, where the polyvinyl acetate is an ivory water-based polyvinyl acetate adhesive.

Further, the re-dispersible latex powder is specifically one or more selected from an ethylene/vinyl acetate copolymer, a vinyl acetate/vinyl tertiary carbonate copolymer, and an acrylic acid copolymer, where the re-dispersible latex powder has a bulk density of 464 kg/m³, a density of 1049 kg/m³, a specific surface area of 346.7 m²/kg, a PH value of 8.2, and an ash content of 9%.

Further, the cellulose ether is hydroxypropyl methyl cellulose ether (HPMC), or the cellulose ether is alternatively one or more selected from methyl cellulose ether, methyl hydroxyethyl cellulose ether and hydroxyethyl cellulose ether.

Further, accuracy of a weighing balance for the materials is +0.01 g.

The embodiments of the present disclosure bring about beneficial effects as follow.

(1) The cement is used to ensure the overall strength of the sound-insulation rubber mortar, and the river sand has a filling effect in the sound-insulation rubber mortar, and serves as a skeleton of the mortar. The environment-friendly sound-insulation rubber mortar has good fluidity and is convenient for construction.

(2) The environment-friendly sound-insulation rubber mortar can further improve the impact strength of the rubber mortar. As the addition of the special glue, the impact strength of the sound-insulation rubber mortar is further improved, which is beneficial to prevent the mortar from being damaged by the people's impact during building activities, this improves the durability of the mortar. The rubber can increase the elastic deformation capacity of the mortar, reduce the dynamic elastic modulus, and weaken the amplitude of vibration generated when sound waves are propagated in the mortar. In addition, the sound waves passing through the mortar can be reflected in all directions, and the intensity of the sound waves reflected in all directions is greatly attenuated after mutual interference and cancellation. In addition, the anti-crack effect of the rubber can also effectively improve the ductility, impact property and durability of the mortar.

(3) The special glue is also an elastomer after solidification, which can further improve the sound insulation performance, impact strength and fluidity of the sound-insulation rubber mortar. The re-dispersible latex powder can improve the fluidity of the sound-insulation rubber mortar and ensure the long-term strength. The cellulose ether can improve the fluidity of the sound-insulation rubber mortar.

(4) The mixed particles of the granular rubber particles and the columnar rubber particles enable a sound vibration cavity to be defined inside the cement, which weakens the amplitude of the sound transmitted in the sound-insulation rubber mortar; in addition, sound interference and cancelation can occur in the disordered rubber cavity, which can improve the sound insulation strength of the sound-insulation rubber mortar.

(5) On basis of the mechanical property of the sound-insulation rubber mortar in the present disclosure meets the specification requirements, the waste tire rubber particles are recycled to the maximum extent.

The raw materials for the test in the embodiments are that: P.042.5R ordinary Portland cement or P.S.A32.5 slag Portland cement of Ishii Cement Factory, that is, the selected cement meets the requirements of GB175-2007 “General Portland cement” and GB1344-1999 “Slag Portland-cement, Portland pozzolana cement and Portland fly-ash cement”.

Regenerated rubber particles, the special glue and the re-dispersible latex powder, hydroxypropyl methyl cellulose ether are provided by Zhuhai Rongshuo green building energy saving technology Co., LTD. The sand is ordinary river sand and medium sand, with a fineness modulus of 2.41, a water absorption rate of 0.38%, a water content of 0.34%, and an apparent density of 2610 kg/m³.

The fluidity of the rubber cement mortar is tested by using a cement fluidity electric jumping table of the material laboratory in Guangdong University of Technology, a YAW-300C flexural tester and a YAW-300C compressive tester of the material laboratory in Guangdong University of Technology. The impact test is conducted by a cantilever beam tester of facility of materials and energy in Guangdong University of Technology.

Embodiment 1: This embodiment relates to an environment-friendly sound-insulation rubber mortar and a preparation method thereof, which includes steps as follows.

The materials for the mortar of each cubic meter are prepared (in mass ratio) as follows: 250 parts of cement, 125 parts of water, 544 parts of river sand, 206 parts of rubber, 0 part of special glue, 1 part of re-dispersible latex powder, and 1 part of cellulose ether.

The cement is slag Portland cement with a label of P.S.A32.5, and the density of the cement is 3200 kg/m³.

The water is ordinary tap water, with a density of 995 kg/m³.

The river sand is medium sand, with a fineness modulus of 2.41, a water absorption rate of 0.38%, and a water content of 0.34%.

The rubber is waste rubber particles, with a particle size of 2-4 mm and an apparent density of 985 kg/m³.

The special glue is an ivory water-based polyvinyl acetate adhesive.

The re-dispersible latex powder has a bulk density of 464 kg/m³, a density of 1049 kg/m³, a specific surface area of 346.7 m²/kg, a PH value of 8.2, and an ash content of 9%. The cellulose ether is hydroxypropyl methyl cellulose ether (HPMC).

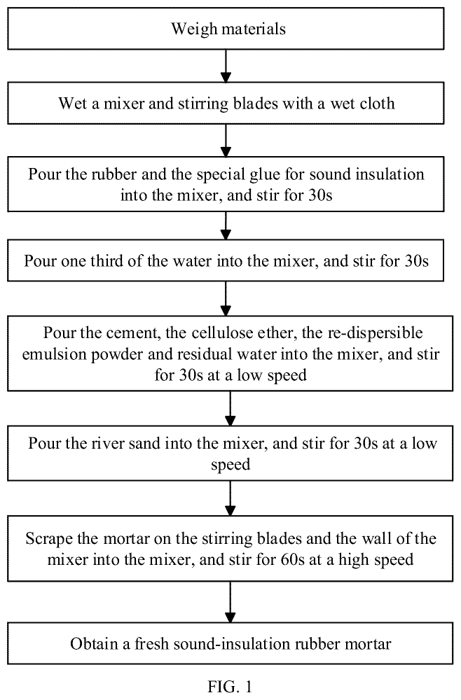

The environment-friendly sound-insulation rubber mortar is prepared with the above materials according to the following steps. As illustrated in FIG. 1, the steps include:
(1) weighting the materials by using an electronic balance, where the accuracy of the weighing balance for the materials is ±0.01 g;
(2) wiping a mixer and stirring blades with a wet cloth, to prevent an inner wall and the blades of the mixer from being excessively dry, and avoid the fluidity of the rubber mortar from being affected;
(3) pouring the cement, the cellulose ether, the re-dispersible latex powder and the water into the mixer, and making the stirring blades stir at a speed of 62±5 r/min for 30 s;
(4) adding a mixture of the sand and the rubber into the mixer, after the rubber and the sand are mixed uniformly in advance (the mixture of the sand and the rubber needs to made within 30 s), and making the stirring blade stir at the speed of 62±5 r/min for 30 s; and
(5) suspending the mixer and scraping the mortar located on the stirring blades and the wall of mixer into the mixer, and then making the stirring blades stir at a speed of 125±10 r/min for 60 s, to obtain a fresh sound-insulation rubber mortar.

In embodiment 1, the rubber replaces the sand of an equal volume, with a replacement rate of 50%. A content ratio of the special glue to the mortar is 0%. A content ratio of each of the re-dispersible latex powder and cellulose ether to the cement is 0.4%. Accordingly, the mortar is named R50Z0F0.4.

Embodiment 2: this embodiment relates to an environment-friendly sound-insulation rubber mortar and a preparation method thereof, which includes steps as follow.

The materials for the mortar of each cubic meter are prepared (in mass ratio) as follows: 250 parts of cement, 125 parts of water, 544 parts of river sand, 206 parts of rubber, 22.5 parts of special glue, 1 part of re-dispersible latex powder, and 1 part of cellulose ether.

The cement is slag Portland cement with a label of P.S.A32.5, and the density of the cement is 3200 kg/m³.

The water is ordinary tap water, with a density of 995 kg/m³.

The river sand is medium sand, with a fineness modulus of 2.41, a water absorption rate of 0.38%, and a water content of 0.34%.

The rubber is waste rubber particles, with a particle size of 2-4 mm and an apparent density of 985 kg/m³.

The special glue is an ivory water-based polyvinyl acetate adhesive.

The re-dispersible latex powder has a bulk density of 464 kg/m³, a density of 1049 kg/m³, a specific surface area of 346.7 m²/kg, a PH value of 8.2, and an ash content of 9%.

The cellulose ether is hydroxypropyl methyl cellulose ether (HPMC).

The environment-friendly sound-insulation rubber mortar is prepared with the above materials according to the following steps. As illustrated in FIG. 1, and the steps includes:
(1) weighting the materials by using an electronic balance, where the accuracy of the weighing balance for the materials is ±0.01 g;
(2) wiping a mixer and stirring blades with a wet cloth, to prevent an inner wall and the blades of the mixer from being excessively dry, and avoid the fluidity of the rubber mortar from being affected;
(3) pouring the rubber and the special glue into a mixer, and making the stirring blades stir at a speed of 62±5 r/min for 30 s;
(4) pouring one third of the water into the mixer, and making the stirring blades stir at the speed of 62±5 r/min for 30 s;
(5) pouring the cement, the cellulose ether, the re-dispersible latex powder and the residual water into the mixer, and making the stirring blades stir at the speed of 62±5 r/min for 30 s;
(6) pouring the river sand into the mixer, and making the stirring blades stir at the speed of 62±5 r/min for 30 s; and
(7) suspending the mixer and scraping the mortar located on the stirring blades and the wall of mixer into the mixer, and then making the stirring blades stir at a speed of 125±10 r/min for 60 s, to obtain a fresh sound-insulation rubber mortar.

In embodiment 2, the rubber replaces the sand of an equal volume, with a replacement rate of 50%. A content ratio of the special glue to the mortar is 2%. A content ratio of each of the re-dispersible latex powder and cellulose ether to the cement is 0.4%. Accordingly, the mortar is named R50Z2F0.4.

Embodiment 3: the components and material proportions of the environment-friendly sound-insulation rubber mortar and the preparation method thereof involved in this embodiment are the same as those in embodiment 2, except that there are 45 parts by mass of the special glue in this embodiment.

In embodiment 3, the rubber replaces the sand of an equal volume, with a replacement rate of 50%. A content ratio of the special glue to the mortar is 4%. A content ratio of each of the re-dispersible latex powder and the cellulose ether to the cement is 0.4%. Accordingly, the mortar is named R50ZAF0.4.

Embodiment 4: the components and material proportions of the environment-friendly sound-insulation rubber mortar and the preparation method thereof involved in this embodiment are the same as those in embodiment 2, except that there are 67.5 parts by mass of the special glue in this embodiment.

In embodiment 4, the rubber replaces the sand of an equal volume, with a replacement rate of 50%. A content ratio of the special glue to the mortar is 6%. A content ratio of each of the re-dispersible latex powder and the cellulose ether to the cement is 0.4%. Accordingly, the mortar is named R50Z6F0.4.

Embodiment 5: the components and material proportions of the environment-friendly sound-insulation rubber mortar and the preparation method thereof involved in this embodiment are the same as those in embodiment 2, except that there are 90 parts by mass of the special glue in this embodiment.

In the embodiment 5, the rubber replaces the sand of an equal volume, with a replacement rate of 50%. A content ratio of the special glue to the mortar is 8%. A content ratio of each of the re-dispersible latex powder and the cellulose ether to the cement is 0.4%. Accordingly, the mortar is named R50Z8F0.4.

In the above embodiments 1-5, the rubber is granular rubber particles, with a particle size of 2-4 mm.

Embodiment 6: the components and material proportions of the environment-friendly sound-insulation rubber mortar and the preparation method thereof involved in this embodiment are the same as those in embodiment 2, except that there are 90 parts by mass of the special glue in this embodiment.

In the embodiment 6, the rubber replaces the sand of an equal volume, with a replacement rate of 50%. A content ratio of the special glue to the mortar is 8%. A content ratio of each of the re-dispersible latex powder and the cellulose ether to the cement is 0.4%. Accordingly, the mortar is named R50Z8F0.4A.

In this embodiment, the rubber is columnar rubber particles, with an average diameter of 1-2 mm and a length-diameter ratio of 3-5.

Embodiment 7: the components and material proportions of the environment-friendly sound-insulation rubber mortar and the preparation method thereof involved in this embodiment are the same as those in embodiment 2, except that there are 90 parts by mass of the special glue in this embodiment.

In the embodiment 7, the rubber replaces the sand of an equal volume, with a replacement rate of 50%. A content ratio of the special glue to the mortar is 8%. A content ratio of each of the re-dispersible latex powder and the cellulose ether to the cement is 0.4%. Accordingly, the mortar is named R50Z8F0.4B.

In this embodiment, the rubber is mixed particles of granular rubber particles and columnar rubber particles, where the columnar particles have an average diameter of 1-2 mm, and a length-diameter ratio is 3-5, and an average diameter of the granular rubber particles is 2-4 mm. The waste rubber particles are the mixed particles of granular rubber particles and columnar rubber particles, and the mass ratio of the granular rubber particles to the columnar rubber particles is 2:1.

Jumping table tests were performed in the present disclosure with reference to “Test method for fluidity of cement mortar” (GB/T 2419-2005), to obtain the fluidity of the sound-insulation rubber mortars based on the tests. With reference to “Test Method of cement mortar strength (ISO)” (GB/T 17671-1999), a prism column with a size of 40 mm×40 mm×160 mm was selected as a test specimen according to the specification, for the compressive test and flexural test, so as to obtain the compressive strength and flexural strength values of the sound-insulation rubber mortar. With reference to the cantilever beam test for the plastic material, a prism column with a size of 15 mm×20 mm×160 mm was selected as a test specimen for impact tests of the cement mortars, so as to obtain the impact strength values of the sound-insulation rubber mortars. With reference to the JGJ/T 70-2009 “Standard for test method of performance on building mortar”, and a triple forming mold with a size of 40 mm×40 mm×160 mm was selected as a test specimen according to the specification. An initial length of the test specimen was measured, and the lengths of the test specimen were tested on the 7th day, 14th day, 21st day, 28th day, 35th day, 42nd day, 49th day, 56th day and 91st day. Based on the Analytic Hierarchy Process and the above performance research results, an optimal proportion was selected. A sound insulation performance of the mortars was tested according to GB/T 19889.7-2005 “Acoustics-Measurement of sound insulation in buildings and of building elements Part 7: Field measurements of floor impact sound insulation” and GB/T 50121-2005 “Evaluation criterion of sound insulation in buildings”. The sound insulation performance of the mortars was evaluated based on the weighted normalized impact sound pressure level of a floor less than or equal to 75 dB as regulated in GB50118-20110 “Code for design of sound insulation of civil buildings”.

The measurement methods for the technical indexes of the present disclosure are all standard measurement methods in the art, and reference may be made to the latest national standards for detail, unless otherwise specified.

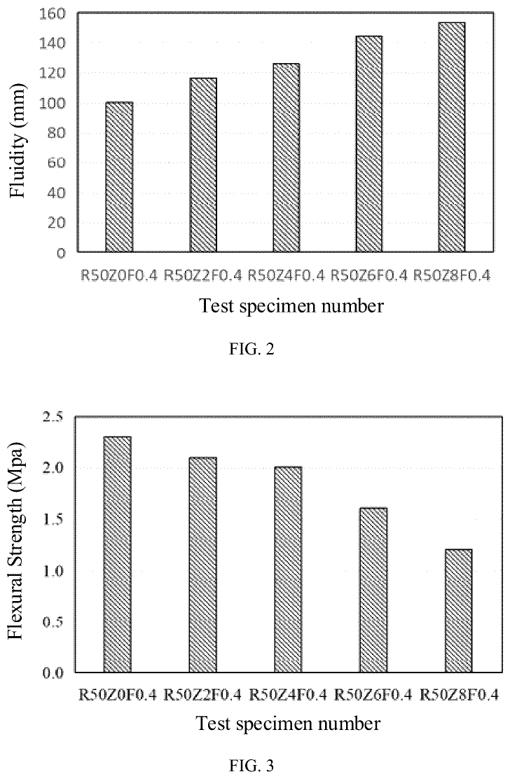

FIG. 2 is a diagram illustrating fluidity results of the sound-insulation rubber mortars. As can be seen from FIG. 2, the fluidity of the sound-insulation rubber mortar is increased with the increase of the content of the special glue. This indicates that the addition of the special glue has a positive effect on the fluidity of the sound-insulation rubber mortar.

FIG. 3 is a diagram illustrating flexural strength results of the sound-insulation rubber mortars. As can be seen from FIG. 3, the flexural strength of the sound-insulation rubber mortar decreases with the increase of the content of special glue. This indicates that the addition of the specialized gum has a negative effect on the flexural property of the sound-insulation rubber mortar.

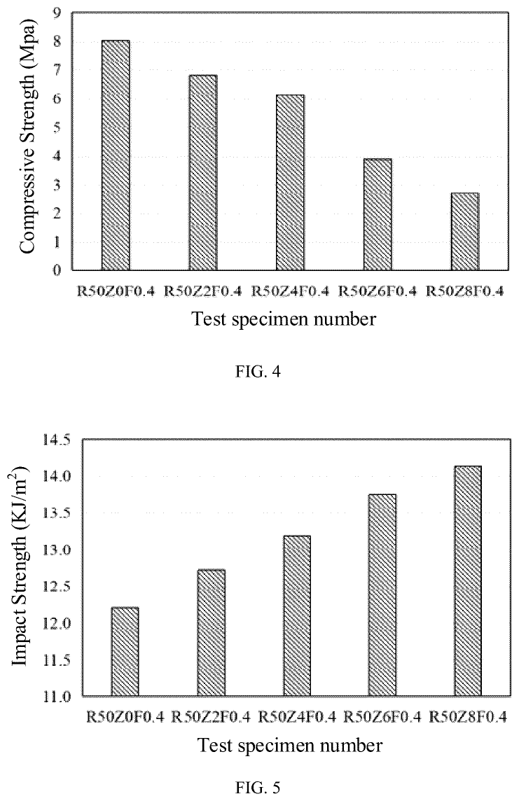

FIG. 4 is diagram illustrating compressive strength results of the sound-insulation rubber mortars. Similarly, the compressive strength of the sound-insulation rubber mortar decreases with the increase of the content of special glue. This indicates that the addition of the special glue has a negative effect on the compressive property of the sound-insulation rubber mortar. When the compressive strength is the minimum, that is, when the content ratio of the special glue is 8% and the compressive strength of the rubber mortar is 2.7 MPa, the compressive strength meets a requirement that the compressive strength of the building floor made of a sound-insulation mortar is greater than or equal to 2 MPa according to the community standard T/GDJSKB008-2022 “Sound insulation mortar for building floor”, meeting the requirements of the actual construction engineering.

FIG. 5 is a diagram illustrating impact strength results of the sound-insulation rubber mortars. As can be seen from FIG. 5, the impact strengths of the sound-insulation rubber mortars exhibit a rising trend with the increase of the content of the special glue. That is, the special glue has a positive effect on the impact property of the sound-insulation rubber mortar where the replacement rate that the rubber replaces the sand is 50%.

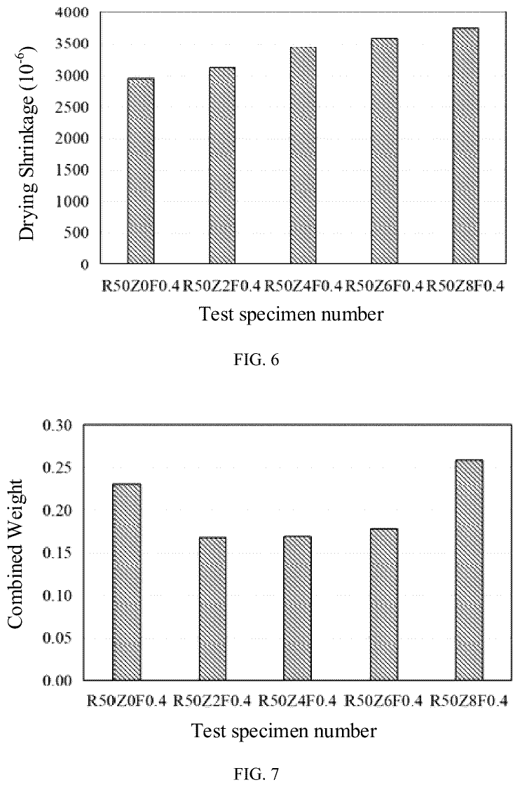

FIG. 6 is a diagram illustrating drying shrinkage results of the sound-insulation rubber mortar test specimens on the 91st day. As can be seen from FIG. 6, when the test specimens are on the 91st day, the drying shrinkage of the sound-insulation rubber mortars was increased at different degrees with the increase of the content of the special glue. That is, the special glue has a negative effect on the drying shrinkage of the sound-insulation rubber mortar.

FIG. 7 is a diagram illustrating combined weights of the sound-insulation rubber mortars in various embodiments, where the combined weight of the sound-insulation rubber mortars in each embodiment was calculated based on the test results such as the fluidity, flexural strength, compressive strength, impact strength, drying shrinkage and the like of the sound-insulation rubber mortar, and comprehensive analysis of various properties of the sound-insulation rubber mortar based on an analytic hierarchy. As can be seen, the comprehensive evaluation of the test specimen R50Z8F0.4 is better.

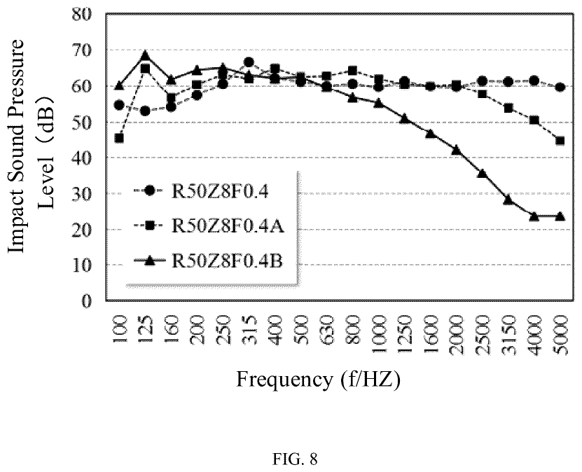

FIG. 8 is a diagram illustrating results of a sound insulation test of the test specimen R50Z8F0.4. According to a method for measuring a floor impact sound insulation single value evaluation amount in GB/T 50121-2005 “Evaluation criterion of sound insulation in buildings”, a single-value evaluation amount of the impact sound insulation after the R50Z8F0.4 rubber mortar being laid for the floor is determined as 67 dB, which is 11 dB lower than a single-value evaluation amount 78 dB of the sound insulation of the reference floor. This meets the requirement where the weighted normalized impact sound pressure level of the floor is less than or equal to 75 dB in the national standard GB50118-2010 “Code for design of sound insulation of civil buildings”.

It was measured that the single-value evaluation amount of the impact sound insulation after R50Z8F0.4A rubber mortar being laid for floor is 65 dB, and the single-value evaluation amount of the impact sound insulation after R50Z8F0.4B rubber mortar being laid for floor is 59 dB, according to the method for measuring a floor impact sound insulation single value evaluation amount in GB/T 50121-2005 “Evaluation criterion of sound insulation in buildings”.

TABLE 1
Results of various properties of the sound-insulation
rubber mortars in various embodiments

| | | | Com- | | Drying | |
|---|---|---|---|---|---|---|
| | Flu- | Flexural | pressive | Impact | Shrink- | Com- |
| Product | idity | Strength | Strength | Strength | age | bined |
| Name | (mm) | (MPa) | (MPa) | (KJ/m²) | (10⁻⁶) | Weight |
| R50Z0F0.4 | 100 | 2.3 | 8 | 12.2029 | 2952.38 | 0.231 |
| R50Z2F0.4 | 116 | 2.1 | 6.8 | 12.7158 | 3121.43 | 0.167 |
| R50Z4F0.4 | 126 | 2 | 6.1 | 13.1867 | 3440.48 | 0.168 |
| R50Z6F0.4 | 144 | 1.6 | 3.9 | 13.7486 | 3583.33 | 0.177 |
| R50Z8F0.4 | 153 | 1.2 | 2.7 | 14.1434 | 3738.10 | 0.258 |
| R50Z8F0.4A | 150 | 1.22 | 2.71 | 14.2 | 3724.20 | 0.261 |
| R50Z8F0.4B | 155 | 1.22 | 2.73 | 14.45 | 3735.4 | 0.272 |

TABLE 2
Data for the sound insulation performance of the
sound-insulation rubber mortar R50Z8F0.4

| Frequency | | | | | | | | | |
|---|---|---|---|---|---|---|---|---|---|
| (HZ) | 100 | 125 | 160 | 200 | 250 | 315 | 400 | 500 | 630 |
| Impact | 54.6 | 53.0 | 54.1 | 57.3 | 60.6 | 66.5 | 62.1 | 61.2 | 60.0 |
| Sound | | | | | | | | | |
| Pressure | | | | | | | | | |
| Level (dB) | | | | | | | | | |
| Frequency | | | | | | | | | |
| (HZ) | 800 | 1000 | 1250 | 1600 | 2000 | 2500 | 3150 | 4000 | 5000 |
| Impact | 60.6 | 59.6 | 61.3 | 59.8 | 59.6 | 61.4 | 61.2 | 61.5 | 59.6 |
| Sound | | | | | | | | | |
| Pressure | | | | | | | | | |
| Level (dB) | | | | | | | | | |

TABLE 3
Data for the sound insulation performance of the sound-
insulation rubber mortar R50Z8F0.4A

| Frequency | | | | | | | | | |
|---|---|---|---|---|---|---|---|---|---|
| (HZ) | 100 | 125 | 160 | 200 | 250 | 315 | 400 | 500 | 630 |
| Impact | 45.3 | 64.8 | 56.6 | 60.4 | 63.1 | 62.0 | 64.8 | 62.5 | 62.7 |
| Sound | | | | | | | | | |
| Pressure | | | | | | | | | |
| Level | | | | | | | | | |
| (dB) | | | | | | | | | |
| Frequency | | | | | | | | | |
| (HZ) | 800 | 1000 | 1250 | 1600 | 2000 | 2500 | 3150 | 4000 | 5000 |
| Impact | 64.2 | 62.0 | 60.4 | 60.0 | 60.4 | 57.6 | 53.8 | 50.5 | 44.6 |
| Sound | | | | | | | | | |
| Pressure | | | | | | | | | |
| Level | | | | | | | | | |
| (dB) | | | | | | | | | |

TABLE 4
Data for the sound insulation performance of the sound-
insulation rubber mortar R50Z8F0.4B

| Frequency | | | | | | | | | |
|---|---|---|---|---|---|---|---|---|---|
| (HZ) | 100 | 125 | 160 | 200 | 250 | 315 | 400 | 500 | 630 |
| Impact | 60.1 | 68.4 | 61.8 | 64.4 | 65.0 | 63.0 | 62.1 | 62.4 | 59.6 |
| Sound | | | | | | | | | |
| Pressure | | | | | | | | | |
| Level | | | | | | | | | |
| (dB) | | | | | | | | | |
| Frequency | | | | | | | | | |
| (HZ) | 800 | 1000 | 1250 | 1600 | 2000 | 2500 | 3150 | 4000 | 5000 |
| Impact | 56.7 | 55.2 | 51.0 | 46.7 | 42.2 | 35.7 | 28.4 | 23.6 | 23.7 |
| Sound | | | | | | | | | |
| Pressure | | | | | | | | | |
| Level | | | | | | | | | |
| (dB) | | | | | | | | | |

As can be seen, the addition of the special glue has a positive effect on the fluidity and the impact strength of the sound-insulation rubber mortar, and has a negative effect on the compressive strength and the flexural strength, and the drying shrinkage performance of the sound-insulation rubber mortar. However, the minimum compressive strength of the sound-insulation rubber mortar still meets the standard requirements. Moreover, based on a mathematical model of the sound-insulation rubber mortar established through a hierarchical analysis method, the fundamental embodiment R50Z8F0.4 is selected, through comprehensive evaluation, as the optimal embodiment, where it was tested that the sound insulation performance of the R50Z8F0.4 enables the sound insulation performance of the building floor to be greatly improved.

By changing the form and the added content of the rubber, the sound insulation performance of the sound-insulation rubber mortar can be further improved. For example, in embodiment 6 in which the granular rubber particles are replaced with the columnar rubber particles, or in embodiment 7 in which the granular rubber particles are replaced with the mixed particles of the granular rubber particles and the columnar rubber particles, the sound insulation performance of the sound insulation rubber can be improved. The reason may be that the irregular rubber particles may define a special-shaped space in the mortar concrete and such space can improve the sound insulation performance of the workpiece.

As can be seen, the environment-friendly sound-insulation rubber mortar of the present disclosure can meet certain compressive strength requirements, enable the impact strength of the cement mortar to be further improved, and enable the sound insulation performance of the building floor to be improved. In addition, the application of the sound-insulation rubber mortar can further relieve the difficulty of recycling the waste tire rubber.

The above contents cannot be interpreted as limiting the specific implementations of the present disclosure to these descriptions. For those skilled in the art to which the present disclosure belongs, several simple deductions or substitutions may also be made without departing from the concept of the present disclosure, and they should be regarded as falling into the protection scope defined by the claims of the present disclosure.

What is claimed is:

1. An environment-friendly sound-insulation rubber mortar, wherein the mortar of each cubic meter is prepared with materials in mass ratio as follows: 200-300 parts of cement, 100-150 parts of water, 500-600 parts of river sand, 180-220 parts of rubber, 0.1-90 parts of special glue, 1-10 parts of re-dispersible latex powder, and 1-10 parts of cellulose ether, and the special glue is a water-based polyvinyl acetate adhesive;
the waste rubber particles are mixed particles of granular rubber particles and columnar rubber particles, a mass ratio of the granular rubber particles to the columnar rubber particles is (2-3):1, and an apparent density of the waste rubber particles is 920-985 kg/m³; and
the river sand is medium sand, and the river sand has a fineness modulus of 2.41, a water absorption rate of 0.38%, and a water content of 0.34%.

2. The environment-friendly sound-insulation rubber mortar of claim 1, wherein the rubber is one or more selected from natural rubber, synthetic rubber, styrene-butadiene rubber, polybutadiene rubber, chloroprene rubber, nitrile rubber, ethylene propylene rubber, polyurethane rubber, polysulfide rubber, acrylate rubber and epichlorohydrin rubber.

3. The environment-friendly sound-insulation rubber mortar of claim 1, wherein the special glue for sound insulation is one or more selected from rubber latex, polyvinyl acetate, urea-formaldehyde, lignin, sodium alkyl sulfonate and guar gum.

4. The environment-friendly sound-insulation rubber mortar of claim 1, wherein the re-dispersible latex powder is one or more selected from an ethylene/vinyl acetate copolymer, a vinyl acetate/vinyl tertiary carbonate copolymer, and an acrylic acid copolymer, wherein the re-dispersible latex powder has a bulk density of 464 kg/m³, a density of 1049 kg/m³, a specific surface area of 346.7 m²/kg, a PH value of 8.2, and an ash content of 9%.

5. The environment-friendly sound-insulation rubber mortar of claim 1, wherein the cellulose ether is hydroxypropyl methyl cellulose ether (HPMC), or the cellulose ether is one or more selected from methyl cellulose ether, methyl hydroxyethyl cellulose ether and hydroxyethyl cellulose ether.

6. A method for preparing the environment-friendly sound-insulation rubber mortar of claim 1, comprising:
(1) preparing materials for the mortar of each cubic meter in such a manner that the mortar of each cubic meter contains materials in mass ratio as follows: 200-300 parts of cement, 100-150 parts of water, 500-600 parts of river sand, 180-220 parts of rubber, 0.1-90 parts of special glue, 1-10 parts of re-dispersible latex powder, and 1-10 parts of cellulose ether;
(2) wetting a mixer and stirring blades, to prevent an inner wall and the blades of the mixer from being excessively dry, and avoid fluidity of the rubber mortar from being affected;
(3) pouring the rubber and the special glue into the mixer, and making the stirring blades stir at a speed of 62±5 r/min for 30-50 s;
(4) pouring one third of the water into the mixer, and making the stirring blades stir at the speed of 62±5 r/min for 30 s;
(5) pouring the cement, the cellulose ether, the re-dispersible latex powder and residual water into the mixer, and making the stirring blades stir at the speed of 62±5 r/min for 30 s;
(6) pouring the river sand into the mixer, and making the stirring blades stir at the speed of 62±5 r/min for 30 s; and
(7) suspending the mixer and scraping the mortar located on the wall and the stirring blades of the mixer into the mixer, and then making the stirring blades stir at a speed of 125±10 r/min for 60 s, to obtain a fresh mortar.

7. The method for preparing the environment-friendly sound-insulation rubber mortar of claim 6, wherein in step (1), a water cement ratio of the mortar is 0.2-0.8; a volume ratio of the cement to fine aggregate is 1:2-1:4; the rubber is added into the mortar by replacing the river sand of an equal volume, with a replacement rate of 20-60%; based on calculation by a mass percentage of the mortar, a content ratio of the special glue for sound insulation is 0.1-10%; and based on calculation by a mass percentage of the cement, a content ratio of each of the re-dispersible latex powder and the cellulose ether is 0.1-0.8%.
